(19) United States
(12) Patent Application Publication
(10) Pub. No.: US 2026/0287027 A1
(43) Pub. Date: Sep. 24, 2026

(54) DOUBLE CLUTCH ARRANGEMENT, DRIVE TRAIN AND WORK MACHINE

(71) Applicant: DEERE & COMPANY, MOLINE, IL (US)

(72) Inventors: MATTHIAS LANG, Mannheim (DE); DAVID MUELLER, Dettenheim (DE); STEFAN RAISCH, Vaihingen an der Enz (DE)

(21) Appl. No.: 19/422,802

(22) Filed: Dec. 17, 2025

(30) Foreign Application Priority Data
Mar. 19, 2025 (EP) 25164610.5
Mar. 19, 2025 (EP) 25164611.3

(51) Int. Cl. F16D 21/06; F16D 23/14

(52) U.S. Cl. CPC F16D 21/06; F16D 23/14

(57) ABSTRACT

The disclosure relates to a dual clutch arrangement for arrangement in a drive train of a work machine or a work machine. The dual clutch arrangement comprises a first clutch cover which is rotatable about an axis of rotation of a first and a second output side, and a second clutch cover which is rotatable about the axis of rotation of the first and the second output sides, and a bearing carrier which is arranged between the first and the second clutch covers. Multiple first bearing elements are arranged between the first clutch cover and the bearing carrier, and multiple second bearing elements are arranged between the second clutch cover and the bearing carrier. The disclosure further relates to a drive train and to a work machine.

### CROSS-REFERENCE TO RELATED APPLICATIONS

This application claims priority to European Patent Application Nos. 25164610.5 and 25164611.3, each filed on Mar. 19, 2025, and which are hereby incorporated by reference.

### TECHNICAL FIELD

The disclosure relates to a double clutch arrangement, a drive train, and a work machine.

### BACKGROUND

Dual clutch arrangements for arrangement between a drive unit and a transmission are known from practice. The known dual clutch devices are in this respect composed of a first clutch pack assigned to a first output side, and in particular a first output shaft, for selective torque transmission between the drive unit and the first output side, and in particular the first output shaft, and of a second clutch pack assigned to a second output side, and in particular a second output shaft, for selective torque transmission between the drive unit and the second output side, and in particular the second output shaft. The first output shaft can in this case be assigned to the first output side and the second output shaft can be assigned to the second output side. Furthermore, in particular dual clutch arrangements in the case of which the associated clutch packs have a common input side assigned to the drive unit are known from practice.

### SUMMARY

An object of the present disclosure is to propose a dual clutch arrangement, a drive train and a work machine. Specifically, an object of the present disclosure can be to propose a dual clutch arrangement, a drive train and a work machine which have a structurally more straightforward and/or a compact design.

This object is achieved by a dual clutch arrangement having the features of one or more embodiments disclosed herein, a drive train having the features of one or more embodiments disclosed herein, and a work machine having the features of one or more embodiments disclosed herein.

According to the disclosure, a dual clutch arrangement, in particular a dual clutch, for arrangement in or for a drive train of a work machine, in particular between a drive unit and a transmission, or for arrangement in or for a work machine is proposed.

The dual clutch arrangement, in particular the dual clutch, comprises a first clutch cover, in particular a first clutch cage, which is rotatable about an axis of rotation A of a first and a second output side, and a second clutch cover, in particular a second clutch cage, which is rotatable about the axis of rotation A of the first and the second output side, and a bearing carrier which is arranged between the first and the second clutch cover. Multiple first bearing elements are arranged between the first clutch cover and the bearing carrier and multiple second bearing elements are arranged between the second clutch cover and the bearing carrier.

In the following text, “connected” can be understood as preferably mechanically connected and/or mechanically operatively connected and/or connected for conjoint rotation. In particular, “connected” can be understood, additionally or alternatively, as drivably connected, that is, torque-transmittingly and/or rotational speed-transmittingly connected, and/or coupled, that is, in particular mechanically coupled and/or rigidly coupled, and/or coupled for conjoint rotation. “Connectable” can preferably be understood as mechanically connectable and/or mechanically operatively connectable and/or connectable for conjoint rotation. Specifically, “connectable” can be understood, additionally or alternatively, as drivably connectable, that is, torque-transmittingly and/or rotational speed-transmittingly connectable, and/or couplable, that is, mechanically couplable and/or rigidly couplable, and/or connectable for conjoint rotation. “Connected” can therefore specifically be understood as a connection of two components which makes it possible to transmit energy and/or force and/or a torque and/or a rotational speed from one component to the other, in particular mechanically. Further components or parts enabling such a transmission of energy and/or force and/or torque and/or transmission of a rotational speed between the two components can be provided between the two components.

The first and the second output side can be in the form of a first and a second output hub or a first and a second hub. The first and the second output side, in particular the first and the second output hub or the first and the second hub, may be tubular with a radially outwardly facing support surface. The first and the second output side may be rotatable about the axis of rotation. The axis of rotation may in particular be in the form of a common axis of rotation.

The first and the second clutch cover, in particular the first and the second clutch cage, may be connectable for conjoint rotation or connected for conjoint rotation. The first and the second clutch cover, in particular the first and the second clutch cage, may form a clutch housing when they are connected to one another for conjoint rotation. The first and the second clutch cover may form one or more cavities, in particular when they are connected to one another. The clutch housing may form the one or more cavities, in particular when the first and the second clutch cover are connected to one another. The first and the second output side, in particular the first and the second hub, may be arranged in the one or more cavities. The first and the second output side, in particular the first and the second hub, may be arranged inside the first and the second clutch cover. The first and the second clutch cover may be rotatable about the axis of rotation, in particular the common axis of rotation.

The dual clutch arrangement may have an input side, in particular a common input side. The first clutch cover may, in particular at least partially, comprise the input side, in particular the common input side. The first clutch cover may, in particular at least partially, be in the form of the input side, in particular the common input side, and/or comprise the input side. The input side may be in the form of the input hub or third hub. The input side, in particular the input hub or the third hub, may be tubular with a radially outwardly facing support surface. The input side, in particular the input hub or the third hub, may be rotatable about the axis of rotation, in particular the common axis of rotation.

Specifically, the first clutch cover may, in particular at least partially, be in the form of an input hub or third hub or comprise the input hub or third hub. The input side, in particular the input hub or the third hub, may have a tubular form in the first clutch cover. The radially outwardly facing support surface may, in particular at least partially, be in the form of a clutch cage. The first clutch cover, preferably the input side, particularly preferably the input hub or third hub, may be connectable to the drive unit.

The dual clutch arrangement, in particular the dual clutch, may comprise a first and a second output shaft. The first and the second output shaft may be connectable to an input side of the transmission. The first output shaft may be connectable or connected to the first output side and/or the second output shaft may be connectable or connected to the second output side, in particular may be connectable or connected by a spline toothing. A respective force and/or torque and/or rotational speed may be transmittable from the first output side to the first output shaft and/or from the second output side to the second output shaft.

The dual clutch arrangement, in particular the dual clutch, may comprise an input shaft. The input shaft may be connectable to the drive unit. The input shaft may be connectable or connected to the input side, in particular connectable or connected by a spline toothing. A force and/or a torque and/or a rotational speed may be transmittable to the input side, in particular to the first clutch cover, in particular from the drive unit. A force and/or a torque and/or a rotational speed may be transmittable from the input shaft to the input side, in particular to the first clutch cover. A force and/or a torque and/or a rotational speed may be transmittable from the drive unit to the input shaft and/or the input side, in particular to the first clutch cover.

The first and/or second output side and/or the input side may each have one or more shaft leadthroughs and/or one or more central passages for the input shaft. The input shaft may at the same time be in the form of a power take-off drive shaft (PTO drive shaft), i.e. in particular drive a power take-off unit. The input shaft, in particular the power take-off drive shaft, may be arranged in the first output side and the input side. The input shaft, in particular the power take-off drive shaft, may be in the form of a solid shaft. The first and the second output shaft may be in the form of hollow shafts. The first output shaft may be arranged, in particular freely rotatably arranged, in the second output shaft. The first and the second output shaft may be arranged coaxially with one another and/or one in the other, in particular freely rotatably one in the other. The first output shaft may extend, preferably concentrically, through the second output shaft. The input shaft, in particular the power take-off drive shaft, may be arranged, in particular freely rotatably arranged, in the first output shaft. The input shaft, in particular the power take-off drive shaft, and the first output shaft may be arranged coaxially with one another and/or one in the other, in particular freely rotatably one in the other. The input shaft may extend, preferably concentrically, through the first output shaft. In this way, a direct and therefore particularly energy-efficient transmission of driving power from the drive unit to a power take-off unit is possible. In addition, the dual clutch arrangement may have a very compact design.

The first and/or the second clutch cover may have a sensor target, in particular an integrally cast sensor target, for ascertaining the rotational speed during operation. The sensor target may be designed in such a way that one or more flanks of the one or more teeth are formed as part of the first and/or the second clutch cover. The sensor target may be designed in such a way that one or more flanks of the one or more teeth are formed in the casting of the first and/or the second clutch cover. This makes it possible to enable a small distance from the sensor.

The bearing carrier may be arranged between the first and the second clutch cover. The bearing carrier may have an annular and/or hollow-cylindrical form. The second bearing elements may be bearing elements different than the first bearing elements. The first bearing elements may be arranged in pairs. The second bearing elements may be arranged in pairs.

The number of first bearing elements may be ≥50, preferably ≥30, particularly preferably ≥20. Specifically, the number of first bearing elements may be ≥10. The number of pairs of first bearing elements may be ≥30, preferably ≥20, particularly preferably ≥15. Specifically, the number of pairs of first bearing elements may be ≥10, preferably 6.

The number of second bearing elements may be ≥50, preferably ≥30, particularly preferably ≥20. Specifically, the number of second bearing elements may be ≥10. The number of pairs of second bearing elements may be ≥30, preferably ≥20, particularly preferably ≥15. Specifically, the number of pairs of second bearing elements may be ≥10, preferably 6.

What is essential for the disclosure is that multiple first bearing elements are arranged between the first clutch cover and the bearing carrier and multiple second bearing elements are arranged between the second clutch cover and the bearing carrier. As a result, the first and second bearing elements can be supported on the bearing carrier and the respective associated clutch cover. Moreover, as a result, fastening elements can additionally be arranged on and/or connected to the first and/or second clutch cover and/or the bearing carrier. Similarly, as a result, the mounting and/or restoration and/or the configuration of the dual clutch arrangement can be made easier and/or made more straightforward in design terms.

In one configuration of the disclosure, the first and/or second bearing elements are arranged coaxially and/or concentrically with respect to the axis of rotation A. The first and/or second bearing elements may be spaced apart and/or arranged with the same radius R from the axis of rotation A.

In one configuration of the disclosure, the first and the second clutch cover, and in particular the bearing carrier, may be connectable or connected, preferably connectable or connected to one another cooperatively, particularly preferably connectable or connected to one another for conjoint rotation and/or secured to one another, by fastening elements. The bearing carrier and the first and the second clutch cover may have apertures, in particular bores or holes. The bearing carrier and the first and the second clutch cover may be connectable or connected to one another, in particular cooperatively, in particular connectable or connected to one another for conjoint rotation and/or secured to one another, by fastening elements arranged in the apertures. The fastening elements may for example be screws or bolts. The fastening elements may be arranged in the apertures, in particular bores or holes. In particular, the fastening elements may be inserted through the apertures, in particular bores or holes. The fastening elements may be connectable or connected, and in particular be secured, to the apertures by screw threads in the apertures. The fastening elements may be arranged coaxially and/or concentrically with respect to the axis of rotation A. The fastening elements may be spaced apart and/or arranged with the same radius R from the axis of rotation A.

In one configuration of the disclosure, the first bearing elements are distributed and/or arranged on a first side of the bearing carrier, in particular on a first side of the bearing carrier facing toward the first clutch cover, in each case in the circumferential direction, in particular at uniform intervals. The second bearing elements are distributed and/or arranged on a second side of the bearing carrier, in particular on a second side of the bearing carrier facing toward the second clutch cover, in each case in the circumferential direction, in particular at uniform intervals. Specifically, the first and second bearing elements may be arranged offset from one another in the circumferential direction. The fastening elements may each be distributed and/or arranged in the circumferential direction on the first and the second clutch cover and the bearing carrier, in particular at uniform intervals. The first and second bearing elements, and in particular the fastening elements, may be arranged offset from one another in the circumferential direction. The first and second bearing elements, and in particular the fastening elements, may be offset from one another tangentially, in particular in the circumferential direction. The first and the second clutch cover may be rotated relative to one another. In other words, the first and the second clutch cover may be rotated relative to one another in such a way that the first and second bearing elements do not come to lie centrally and/or come to lie asymmetrically with respect to one another, in particular in the axial direction of the axis of rotation A or along the axis of rotation A. The first and second bearing elements may thus be radially rotated and/or offset tangentially, in particular with respect to the circumferential direction. The first and second bearing elements, and in particular the fastening elements, can thus be arranged directly next to one another, in particular in the circumferential direction, but not centrally with respect to one another or superposed one on another. The first and second bearing elements, and in particular the fastening elements, may have predefinable spacings. The first and second bearing elements, and in particular the fastening elements, can thus operate against a solid part of the oppositely situated clutch cover. Advantageously, as a result, there is sufficient space between the first and second bearing elements for an arrangement of the fastening elements and/or the connection of the two clutch covers by the fastening elements.

In one configuration of the disclosure, the first bearing elements are in the form of first springs or first spring pairs or first helical compression springs and/or the second bearing elements are in the form of second springs or second spring pairs or second helical compression springs. The fastening elements may be in the form of screws.

In one configuration of the disclosure, the dual clutch arrangement comprises a first and a second clutch pack. The first clutch pack may be configured such, or in particular in such a way, that it connects the first clutch cover, in particular the first clutch cage, to the first output side when the first clutch pack is in engagement, and/or the second clutch pack may be configured such, or in particular in such a way, that it connects the second clutch cover, in particular the second clutch cage, to the second output side when the second clutch pack is in engagement.

The first output side, and in particular the first output shaft, can be assigned the first clutch pack for selective transmission of an energy and/or force and/or a torque and/or a rotational speed between the input side, and/or in particular the input shaft, and the first output side, and/or in particular the first output shaft. In other words, an energy and/or force and/or a torque and/or a rotational speed can be selectively transmittable from the input side, and/or in particular the input shaft, to the first output side, and/or in particular the first output shaft, by the first clutch pack. The first clutch pack can be connectable or connected to the first output side.

The second output side, and in particular the second output shaft, can be assigned the second clutch pack for selective transmission of an energy and/or force and/or a torque and/or a rotational speed between the input side, and/or in particular the input shaft, and the second output side, and/or in particular the second output shaft. In other words, an energy and/or force and/or a torque and/or a rotational speed can be selectively transmittable from the input side, and/or in particular the input shaft, to the second output side, and/or in particular the second output shaft, by the second clutch pack. The second clutch pack can be connectable or connected to the second output side.

The first clutch pack may be arranged, in particular at least partially, in and/or on the first clutch cage. The second clutch pack may be arranged, in particular at least partially, in and/or on the second clutch cage. The first and the second clutch pack may be arranged in the clutch housing. The first and the second clutch pack may be enclosed by the first and the second clutch cover, or in particular the clutch housing. The first and the second clutch pack may have radially symmetrical forms and/or be arranged such that they are radially symmetrical. The bearing carrier may be arranged between the first and the second clutch pack. The dual clutch arrangement has the advantages mentioned above. In addition, the forces acting due to the actuation of the clutch packs can be supported particularly reliably. Advantageously, the restoration of the pistons and/or clutch packs can be affected by the first and second bearing elements.

In one configuration of the disclosure, the first output side is arranged radially on the inside of the first and the second clutch cover, in particular inside of the clutch housing. The first output side may be arranged, in particular at least partially, radially on the inside of the second output side. The second output side may be arranged radially on the inside of the first and the second clutch cover, in particular inside of the clutch housing. The first output side may be arranged, at least partially, in the second output side in the axial direction or along the axis of rotation A.

In one configuration of the disclosure, the first and/or the second output side are in the form of a hollow hub and/or a hollow shaft. In one configuration of the disclosure, the first and the second clutch pack are arranged axially, in particular axially offset. The first and the second clutch pack can be axially nested or axially offset. Specifically, the first and the second clutch pack may be nested or offset in the direction of or along the axis of rotation A. This makes it possible to realize a compact form and arrangement of the dual clutch arrangement.

In one configuration of the disclosure, the first output side is mounted on the first clutch cover and the second output side is mounted on the second clutch cover. Specifically, the first output side may be mounted on the first clutch cover by a first bearing and the second output side may be mounted on the second clutch cover by a second bearing. The first and the second output side may also be mounted on the clutch housing. The first and/or the second bearing may be in the form of a ball bearing, rolling bearing or hydrodynamic plain bearing. Advantageously, the lubricant of the lubricating-oil path or pressurized-oil path can be used for a hydrodynamic plain bearing. Advantageously, as a result the dual clutch arrangement can be configured particularly straightforwardly and as a cohesive module in design terms, and/or in particular mounted on the transmission. Moreover, as a result, the mounting of the first and second output sides and/or of the first and second output shafts can be made easier and/or configured in design terms.

In one configuration of the disclosure, the first and/or the second clutch pack are in the form of a multi-disk clutch arrangement, preferably a wet-running or dry multi-disk clutch arrangement. The multi-disk clutch arrangement may comprise at least one friction disk which is provided with friction linings and is connected to an input or output disk carrier for conjoint rotation. The multi-disk clutch arrangement may comprise at least two plates arranged on one or on the other side of the at least one friction disk and connected to the respective other of the input and output disk carrier for conjoint rotation.

The first and the second clutch cover may each comprise an input disk carrier. Specifically, the first and the second clutch cover may each, at least partially, be in the form of an input disk carrier. The first and the second output side may each comprise an output disk carrier. Specifically, the first and the second output side may each, at least partially, be in the form of an output disk carrier.

Each clutch pack may operate between a disengaged position and an engaged position, in which the plates and the friction disks clamp the friction linings such that an energy and/or force and/or a torque and/or a rotational speed can be transmitted between the input disk carrier and an output disk carrier.

The disclosure further relates to a drive train having a dual clutch arrangement. In one configuration of the disclosure, the drive train comprises a drive unit and a transmission, wherein the drive unit is connectable or connected to the first clutch cover and/or the first and the second output side is in particular selectively connectable or connected to the transmission. The drive unit can be, for example, an internal combustion engine or an electric motor. The transmission may be a dual clutch transmission, in particular with at least one winding path gear.

The disclosure further relates to a work machine which has a dual clutch arrangement, or a drive train.

The work machine can be a construction machine or a towing vehicle, preferably an agricultural towing vehicle, for example a tractor. The work machine has the above-described advantages.

The work machine can comprise the drive unit. The work machine can be drivable with a rotational speed and/or force and/or a torque of a drive unit. The drive unit can be, for example, an internal combustion engine or an electric motor. The work machine can comprise the one or more ground-engaging means. The ground-engaging means can support and/or carry the work machine on the ground. The ground-engaging means can be wheels or tracks or chains. In particular, the ground-engaging means can be front wheels and rear wheels.

Other features and aspects will become apparent by consideration of the detailed description, claims, and accompanying drawings.

### BRIEF DESCRIPTION OF THE DRAWINGS

The disclosure and further advantages and advantageous developments and configurations of the disclosure, both in terms of the hardware and of the method, will be explained in more detail below by example embodiments and with reference to the drawing. Components with an equivalent or comparable function are identified here by the same reference signs.

FIG. 1 shows a schematic illustration of a first example embodiment of a work machine according to the disclosure, and

FIG. 2 shows a schematic illustration of the first example embodiment of the dual clutch arrangement according to the disclosure, and

FIG. 3 shows another schematic illustration of the first example embodiment of the dual clutch arrangement according to the disclosure from FIG. 2, and

FIG. 4 shows another schematic illustration of the first example embodiment of the dual clutch arrangement according to the disclosure from FIG. 2, and

FIG. 5 shows a schematic illustration of a second example embodiment of the dual clutch arrangement according to the disclosure, and

FIG. 6 shows a schematic illustration of a drive train according to the disclosure.

Like reference numerals are used to indicate like elements throughout the several figures.

### DETAILED DESCRIPTION

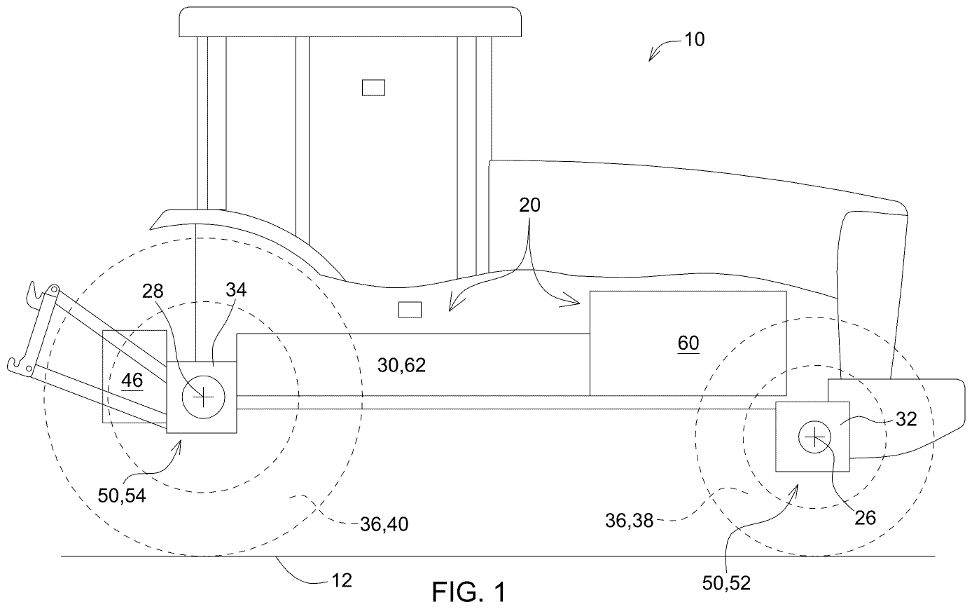

FIG. 1 shows a schematic illustration of a first example embodiment of a work machine 10 according to the disclosure, here of an agricultural towing vehicle or tractor, in particular having a dual clutch arrangement 30 according to the disclosure. The work machine 10 comprises a drive train 20 according to the disclosure. In addition, the work machine 10 is drivable by the drive train 20.

The work machine 10, in particular the drive train 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The work machine 10, in particular the drive device 20, can comprise a traction drive 50, in particular a front-axle drive 52 and a rear-axle drive 54. The work machine 10 can have one or more ground-engaging means 36, in this case illustrated in the form of wheels 38, 40, which engage with an underlying surface 12 in order to transmit drive forces and/or by way of which the work machine 10 is supported on the underlying surface 12. Alternatively, the ground-engaging means 36 can also be configured and arranged as tracks or chains.

The traction drive 50 can comprise the first vehicle axle 26 and/or the second vehicle axle 28 and/or a first differential 32 and/or a second differential 34 and/or the one or more ground-engaging means 36. The first vehicle axle 26 can be connected to the first differential 32. The second vehicle axle 28 can be connected to the second differential 34.

The work machine 10, in particular the drive train 20, comprises a drive unit 60, in particular an internal combustion engine or an electric motor, and a transmission 62. With the drive train 20, in particular the drive unit 60, a rotational movement and/or force and/or a torque and/or a rotational speed can be generatable and can be transmissible, in particular via the transmission 62, to the first and/or second vehicle axle 26, 28. The first and/or second vehicle axle 26, 28 convert the rotational movement and/or force and/or the torque and/or the rotational speed into a rotational movement and/or force and/or torque and/or rotational speed of one or more ground-engaging means 36, and thus into propulsion of the work machine 10.

The work machine 10, in particular the drive train 20, can comprise a first power output 46. The first power output may comprise a power take-off unit 222. The first power output 46 can be provided for the purpose of driving an implement (not shown), which can be attached to the work machine 10 via an interface (e.g. three-point interface).

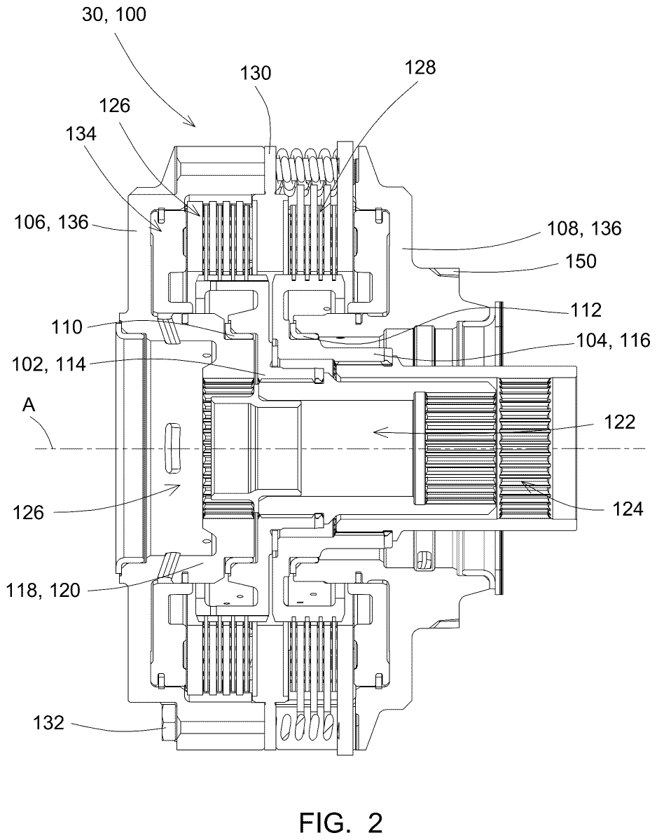

FIG. 2 shows a schematic illustration of a first example embodiment of the dual clutch arrangement 30 according to the disclosure. The dual clutch arrangement 30 shown in FIG. 2 substantially corresponds to the dual clutch arrangement 30 shown in FIG. 1, and therefore only details and/or points of differentiation will be discussed below. The work machine 10 illustrated in FIG. 1 or the drive train 20 can comprise the dual clutch arrangement 30 illustrated in FIG. 2.

The dual clutch arrangement 30, in particular a dual clutch 100, for arrangement in a drive train 20 of a work machine 10 or a work machine 10 comprises a first clutch cover 106 which is rotatable about an axis of rotation A of a first and a second output side 102, 104 of the dual clutch arrangement, and a second clutch cover 108 which is rotatable about the axis of rotation A of the first and the second output side 102, 104. The first output side 102 is mounted on the first clutch cover 106 and the second output side 104 is mounted on the second clutch cover 108. Specifically, the first output side 102 is mounted on the first clutch cover 106 by a first bearing 110, and the second output side 104 is mounted on the second clutch cover 108 by a second bearing 112. The dual clutch arrangement 30 further comprises a bearing carrier 130 arranged between the first and the second clutch cover 106, 108. Multiple first bearing elements 138 are arranged between the first clutch cover 106 and the bearing carrier 130 and multiple second bearing elements 140 are arranged between the second clutch cover 108 and the bearing carrier 130.

The first and the second output side 102, 104 are in the form of a first and a second hub 114, 116. The first and the second output side 102, 104 are rotatable about the axis of rotation A. The dual clutch arrangement 30 further has an input side 118, in particular a common input side. The first clutch cover 106 comprises the input side 118, in particular the common input side. The first clutch cover 106 is, in particular at least partially, in the form of the input side 118, in particular the common input side, and comprises the input side 118. The input side 118 is in the form of a third hub 120. The input side 118 or the third hub 120 is rotatable about the axis of rotation A. The first clutch cover 106, preferably the input side 118 or the third hub 120, may be connectable to the drive unit 60.

The dual clutch arrangement 30, in particular the dual clutch 100, may comprise a first and a second output shaft (not illustrated). The first output shaft may be connectable or connected to the first output side 102, in particular the first hub 114, and/or the second output shaft may be connectable or connected to the second output side 104, in particular the second hub 116, in particular may be connectable or connected by a spline toothing. The dual clutch arrangement 30, in particular the dual clutch 100, may comprise the input shaft (not illustrated). The input shaft may be connectable to the drive unit 60. The input shaft may be connectable or connected to the input side 118 or the third hub 120, in particular connectable or connected by a spline toothing.

The first output side 102 may be arranged radially on the inside of the first and the second clutch cover 106, 108, in particular inside of a clutch housing 136. The first output side 106 may be arranged partially radially on the inside of the second output side 108. The second output side 108 may be arranged radially on the inside of the first and the second clutch cover 106, 108, in particular inside of the clutch housing 136. The first and/or the second output side 106, 108 and/or the input side 118 may be in the form of a hollow hub and/or a hollow shaft. The first and/or the second output side 106, 108 and/or the input side 118 may have a respective shaft leadthrough 122, 124, 126 and/or a respective central passage for an input shaft.

The dual clutch arrangement 30, in particular the dual clutch 100, comprises a first and a second clutch pack 126, 128. The first clutch pack 126 is configured such that it connects the first clutch cover 106 to the first output side 102 when the first clutch pack 126 is in engagement, and/or the second clutch pack 128 is configured such that it connects the second clutch cover 108 to the second output side 104 when the second clutch pack 128 is in engagement.

As a result, when a force and/or a torque and/or a rotational speed is transmitted from the drive unit to the input side 118, in particular to the first clutch cover 106, a force and/or a torque and/or a rotational speed can be transmitted via the first clutch pack 126 to the first output side 102. As an alternative or in addition, when a force and/or a torque and/or a rotational speed is transmitted from the drive unit to the input side 118, in particular to the first clutch cover 106, a force and/or a torque and/or a rotational speed can be transmitted via the second clutch pack 128 to the second output side 104. The first and the second clutch pack 126, 128 are arranged axially in the direction of or along the axis of rotation A. Furthermore, the first and/or the second clutch pack 126, 128 are in the form of a multi-disk clutch arrangement, preferably a wet-running multi-disk clutch arrangement.

The first and the second clutch cover 106, 108 may be connectable or connected for conjoint rotation, in particular by fastening elements 132. The first and the second clutch cover 106, 108 and the bearing carrier 130 may be connectable or connected to the fastening elements 132. To this end, the dual clutch arrangement 30 may comprise one or more fastening elements 132. The first and the second clutch cover 106, 108 may, in particular when they are connected to one another, form one or more cavities 134 and/or a clutch housing 136. The first and the second clutch cover 106, 108 may be rotatable about the axis of rotation A. The first and/or the second clutch pack 126, 128 may be arranged in the one or more cavities 134 and/or in the clutch housing 136. The first and/or the second clutch cover 106, 108 may further have a sensor target 150, in particular an integrally cast sensor target, for ascertaining the rotational speed during operation. The sensor target 150 may be arranged on, preferably integrated in, the second clutch cover 108.

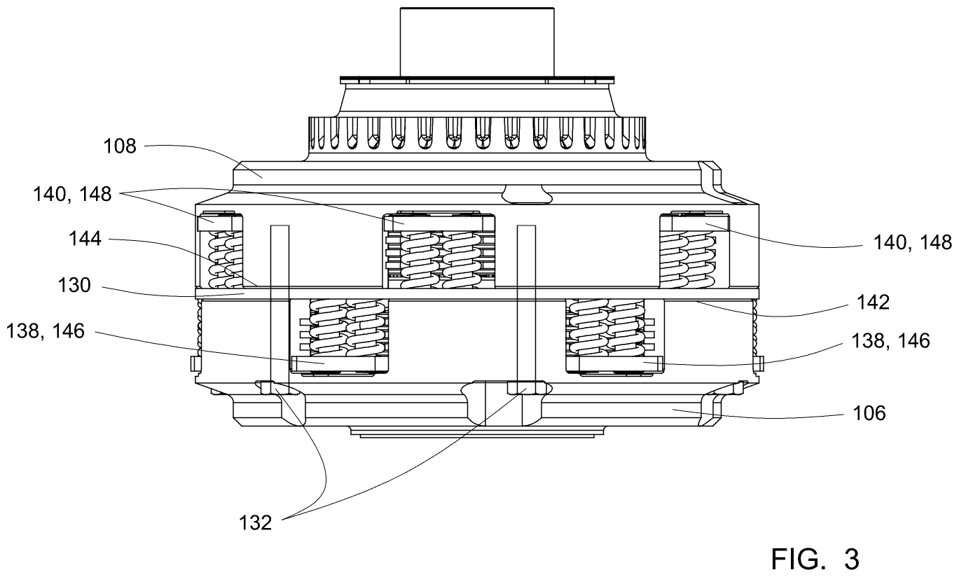

FIG. 3 shows another schematic illustration of the first example embodiment of the dual clutch arrangement 30 according to the disclosure. The dual clutch arrangement 30 shown in FIG. 3 substantially corresponds to the dual clutch arrangement 30 shown in FIGS. 1 and 2, and therefore only details and/or points of differentiation will be discussed below. The work machine 10 illustrated in FIG. 1 or the drive train 20 can comprise the dual clutch arrangement 30 illustrated in FIG. 3.

The first bearing elements 138 are distributed and/or arranged on a first side 142 of the bearing carrier 130, in particular on a first side 142 of the bearing carrier 130 facing toward the first clutch cover 106, in each case in the circumferential direction. The second bearing elements 140 are distributed and/or arranged on a second side 144 of the bearing carrier 130, in particular on a second side 144 of the bearing carrier 130 facing toward the second clutch cover 108, in each case in the circumferential direction. The fastening elements 132 are distributed and/or arranged in each case in the circumferential direction on the first and the second clutch cover 106, 108 and the bearing carrier 130. The first bearing elements 138 may be in the form of first springs or first spring pairs and the second bearing elements 140 may be in the form of second springs or second spring pairs.

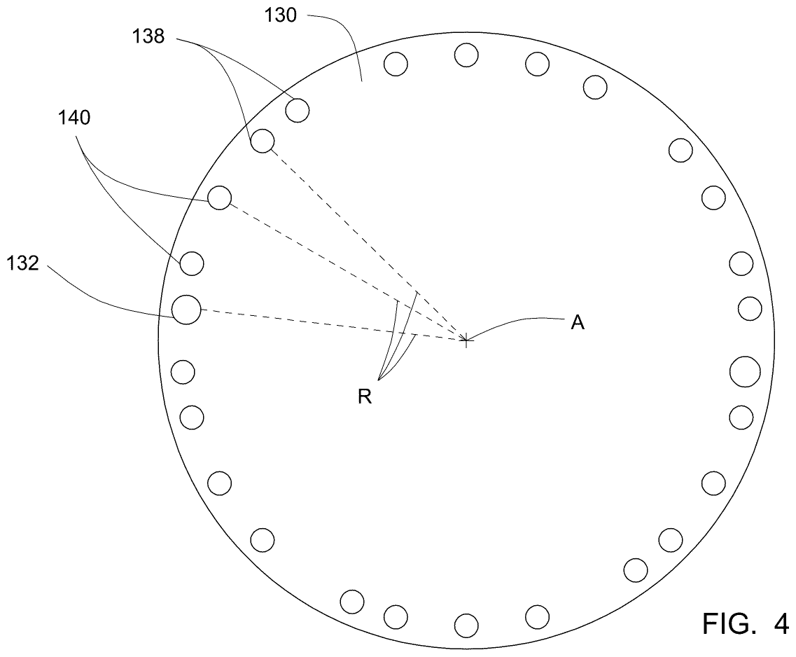

FIG. 4 shows another schematic illustration of the first example embodiment of the dual clutch arrangement 30 according to the disclosure. The dual clutch arrangement 30 shown in FIG. 4 substantially corresponds to the dual clutch arrangement 30 shown in FIGS. 1 to 3, and therefore only details and/or points of differentiation will be discussed below. The work machine 10 illustrated in FIG. 1 or the drive train 20 can comprise the dual clutch arrangement 30 illustrated in FIG. 4.

The first and second bearing elements 138, 140 and the fastening elements 132 are arranged on the bearing carrier 130 offset from one another in the circumferential direction. In other words, the first and second bearing elements 138, 140 are not arranged centrally and/or symmetrically with respect to one another, but rather are arranged tangentially offset from one another. The fastening elements 132 and/or the first and/or second bearing elements 138, 140 are arranged coaxially and/or concentrically with respect to the axis of rotation A. Moreover, the fastening elements 132 and/or the first and/or second bearing elements 138, 140 may be spaced apart and/or arranged with the same radius R from the axis of rotation A.

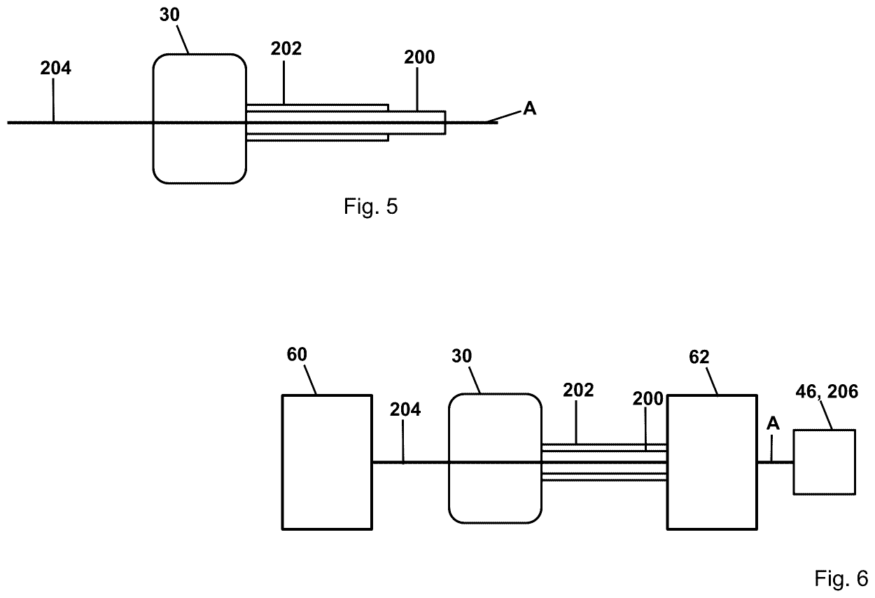

FIG. 5 shows a schematic illustration of a second example embodiment of the dual clutch arrangement 30 according to the disclosure. The dual clutch arrangement 30 shown in FIG. 5 substantially corresponds to the dual clutch arrangement 30 shown in FIGS. 1 to 4, and therefore only details and/or points of differentiation will be discussed below. The work machine 10 illustrated in FIG. 1 or the drive train 20 can comprise the dual clutch arrangement 30 illustrated in FIG. 5.

The dual clutch arrangement 30, in particular the dual clutch 100, comprises a first and a second output shaft 200, 202. The first output shaft 200 is connected to the first output side 102. The second output shaft 202 is connected to the second output side 104, in particular by a spline toothing. The dual clutch arrangement further comprises an input shaft 204. The input shaft 204 may be connectable to the drive unit 60. The input shaft 204 is connected to the input side 118, in particular by a spline toothing. The first and the second output side 102, 104 and the input side 118 each have a shaft leadthrough and/or a central passage for the input shaft 204. The input shaft 204 is in the form of a solid shaft. The first and the second output shaft 200, 202 are in the form of hollow shafts. The first output shaft 200 is arranged, in particular freely rotatably arranged, in the second output shaft 202. The first and the second output shaft 200, 202 are arranged coaxially with one another. The input shaft 204 is arranged, in particular freely rotatably arranged, in the first output shaft 200. Furthermore, the input shaft 204 is arranged, in particular freely rotatably arranged, in the input side 118 and the first output side 102. The input shaft 204 and the first and the second output shaft 200, 202 are arranged coaxially with one another. The input shaft 204 extends through the first output shaft 200.

FIG. 6 shows a schematic illustration of the drive train 20 according to the disclosure. The drive train 20 shown in FIG. 6 comprises the dual clutch arrangement 30 shown in FIGS. 1 to 5, and therefore only details and/or points of differentiation will be discussed below. The work machine 10 illustrated in FIG. 1 may comprise the drive train 20 illustrated in FIG. 6.

The drive train comprises the drive unit 60 and the transmission 62. The drive unit 60 is connected to the first clutch cover 106 via or by the input shaft 204 and the input side 118.

The first and the second output side 102, 104 are, in particular selectively, connectable or connected to the transmission 62 via or by the first and the second output shaft 200, 202. The transmission 62 may be a dual clutch transmission, in particular with at least one winding path gear.

The input shaft 204 is at the same time in the form of a power take-off drive shaft (PTO drive shaft) and may drive the first power output 46, preferably the power take-off unit 206. In this way, a direct and therefore particularly energy-efficient transmission of driving power from the drive unit 60 to the first power output 46 and/or the power take-off unit 206 is possible.

A force and/or a torque and/or a rotational speed may be transmittable from the drive unit 60 to the input side 118, in particular to the first clutch cover 106, via the or by the input shaft 204. A force and/or a torque and/or a rotational speed may be transmittable from the drive unit 60 to the first power output 46, in particular to the power take-off unit 206, via the or by the input shaft 204.

A force and/or a torque and/or a rotational speed may be transmittable from the first output side 102 to the transmission 62 via the or by the first output shaft 200 and/or a force and/or a torque and/or a rotational speed may be transmittable from the second output side 104 to the transmission 62 via the or by the second output shaft 202.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A dual clutch arrangement for arrangement in a drive train of a work machine or a work machine, comprising:
a first clutch cover rotatable about an axis of rotation of a first output side and a second output side,
a second clutch cover rotatable about the axis of rotation of the first and the second output side, and
a bearing carrier arranged between the first and the second clutch cover,
wherein multiple first bearing elements are arranged between the first clutch cover and the bearing carrier and multiple second bearing elements are arranged between the second clutch cover and the bearing carrier.

2. The dual clutch arrangement of claim 1, wherein the first and second bearing elements are arranged coaxially or concentrically with respect to the axis of rotation, or the first or second bearing elements are spaced apart and arranged with the same radius from the axis of rotation.

3. The dual clutch arrangement of claim 1, wherein the first and the second clutch covers, and the bearing carrier are connectable or connected by fastening elements.

4. The dual clutch arrangement of claim 1, wherein the first bearing elements are distributed or arranged on a first side of the bearing carrier, in each case in the circumferential direction, or the second bearing elements are distributed or arranged on a second side of the bearing carrier, in each case in the circumferential direction.

5. The dual clutch arrangement of claim 1, wherein the first bearing elements are in the form of first springs or first spring pairs, and the second bearing elements are in the form of second springs or second spring pairs.

6. The dual clutch arrangement of claim 1, further comprising a first clutch pack and a second clutch pack, wherein the first clutch pack is configured to connect the first clutch cover to the first output side when the first clutch pack is in engagement, or the second clutch pack is configured such to connect the second clutch cover to the second output side when the second clutch pack is in engagement.

7. The dual clutch arrangement of claim 1, wherein the first output side is arranged radially on the inside of the first and the second clutch covers.

8. The dual clutch arrangement of claim 1, wherein the first and the second output sides are in the form of a hollow hub or a hollow shaft.

9. The dual clutch arrangement of claim 6, wherein the first and the second clutch packs are arranged axially.

10. The dual clutch arrangement of claim 1, wherein the first output side is mounted on the first clutch cover and the second output side is mounted on the second clutch cover.

11. The dual clutch arrangement of claim 1, wherein the first output side is mounted on the first clutch cover by a first bearing, and the second output side is mounted on the second clutch cover by a second bearing.

12. The dual clutch arrangement of claim 6, wherein at least one of the first or the second clutch pack is in the form of a multi-disk clutch arrangement, including a wet-running or dry multi-disk clutch arrangement.

13. A drive train comprising:
a dual clutch arrangement including:
a first clutch cover rotatable about an axis of rotation of a first output side and a second output side,
a second clutch cover rotatable about the axis of rotation of the first and the second output side, and
a bearing carrier arranged between the first and the second clutch cover,
wherein multiple first bearing elements are arranged between the first clutch cover and the bearing carrier and multiple second bearing elements are arranged between the second clutch cover and the bearing carrier.

14. The drive train of claim 13, further comprising a drive unit and a transmission, wherein the drive unit is connectable or connected to the first clutch cover, or the first and the second output side being connectable or connected to the transmission.

15. A work machine comprising:
a dual clutch arrangement including:
a first clutch cover rotatable about an axis of rotation of a first output side and a second output side,
a second clutch cover rotatable about the axis of rotation of the first and the second output side, and
a bearing carrier arranged between the first and the second clutch cover,
wherein multiple first bearing elements are arranged between the first clutch cover and the bearing carrier and multiple second bearing elements are arranged between the second clutch cover and the bearing carrier.
